(19) United States
(12) Patent Application Publication
(10) Pub. No.: US 2014/0009563 A1
(43) Pub. Date: Jan. 9, 2014

(54) NON-VIDEO CODECS WITH VIDEO CONFERENCING

(71) Applicants: Matthew John Leske, Stockholm (SE); Harald Tveit Alvestrand, Trondheim (NO); Martin Öhman, Stockholm (SE); Per Kjellander, Farsta (SE)

(72) Inventors: Matthew John Leske, Stockholm (SE); Harald Tveit Alvestrand, Trondheim (NO); Martin Öhman, Stockholm (SE); Per Kjellander, Farsta (SE)

(73) Assignee: GOOGLE INC., Mountain View, CA (US)

(21) Appl. No.: 13/541,141

(22) Filed: Jul. 3, 2012

(51) Int. Cl. H04N 7/15

(52) U.S. Cl. 348/14.08; 348/E07.083

(57) ABSTRACT

Systems and methods for utilizing a non-video codec in connection with a video conferencing application are disclosed herein. Standard video codec(s) can be employed with the video conferencing application for video-based images. When a non-video image designated for sharing by way of the video conferencing application is identified, a non-video codec can be employed instead of the video codec(s) for the identified non-video image. As a result, the non-video image can be transferred more efficiently and can be rendered at the destination in higher quality.

### TECHNICAL FIELD

This disclosure generally relates to employing non-video codecs for encoding/decoding non-video images transferred by way of a video conferencing session.

### BACKGROUND

Conventional video conferencing applications encode data to be transferred between conference participants in order to efficiently compress that data. The recipient can then decode the data and render it at the destination. Given the relatively large size of video data that is customarily transferred by way of video conferencing applications, these video codecs are conventionally optimized for video images.

For example, conventional video codecs can efficiently encode video images that include a high degree of motion. These video images generally include few sharp edges in the rapidly changing image and display smooth, natural color gradients.

However, a common scenario arises in which non-video images are transferred by way of the video conferencing application/session. For example, it is a common scenario in which one participant would like to share a non-video image such as the contents of his or her screen with another video conferencing participant. Typically, this is accomplished by way of a screen capture that is then encoded by the same video codecs that are used for video data being transferred during the video conference. Conventional approaches have yet to recognize the difficulties associated with this approach.

For example, unlike video images that are expected to change rapidly, include few sharp edges, and display smooth, natural color gradients, a screen capture or other non-video image (e.g., a still image of text, graphs, charts, etc.) is typically low in motion, has many sharp edges that are not expected to change often, and typically has large blocks of a single color that also are not expected to change often.

As a result, the non-video image are encoded by conventional video conferencing systems in a manner that is optimal for video images but not optimal for non-video images and, once decoded, can be of poorer quality than desirable when rendered at the other end.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its purpose is to present some concepts of the specification in a simplified form as a prelude to the more detailed description that is presented in this disclosure.

Systems and methods disclosed herein relate to utilizing a non-video codec for an identified non-video image in connection with a video conference session. A conference detection component can be configured to identify a video conference session between a first device and a second device. Generally, the video conference session employs one or more video codecs to facilitate communication between the first device and the second device. An image detection component can be configured to identify a non-video image in response to the non-video image being designated for transfer by way of the video conference session. A codec component can be configured to utilize a non-video codec for the non-video image, wherein the non-video codec differs from the one or more video codecs.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a high-level block diagram of an example system that can employ a non-video codec to encode/decode a non-video image designated for transfer by way of a video conferencing session;

FIG. 2 depicts an example block diagram of a system in which the non-video image is a screen capture performed by the first device and shared by way of the video conference session with the second device in accordance with certain embodiments of this disclosure;

FIG. 3 illustrates a block diagram illustration of example features of various embodiments of a non-video codec in accordance with certain embodiments of this disclosure;

FIG. 4 illustrates a block diagram of a system integrated with a video conferencing application that can employ a non-video codec to encode/decode a non-video image designated for transfer by way of a video conferencing session in accordance with certain embodiments of this disclosure;

FIG. 5 illustrates an example methodology for employing a non-video codec to encode/decode a non-video image designated for transfer by way of a video conferencing session in accordance with certain embodiments of this disclosure;

FIG. 6 illustrates an example methodology that can provide for additional features associated with identifying the non-video image in accordance with certain embodiments of this disclosure;

FIG. 7 illustrates an example methodology that can provide for additional features associated with utilizing the non-video codec in accordance with certain embodiments of this disclosure;

FIG. 8 illustrates an example methodology that can provide for additional features relating to utilizing non-video codec for encoding non-video image in accordance with certain embodiments of this disclosure;

FIG. 9 illustrates an example schematic block diagram for a computing environment in accordance with certain embodiments of this disclosure; and

FIG. 10 illustrates an example block diagram of a computer operable to execute certain embodiments of this disclosure.

### DETAILED DESCRIPTION

### Example Embodiments that Interface a Video Conference Application

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

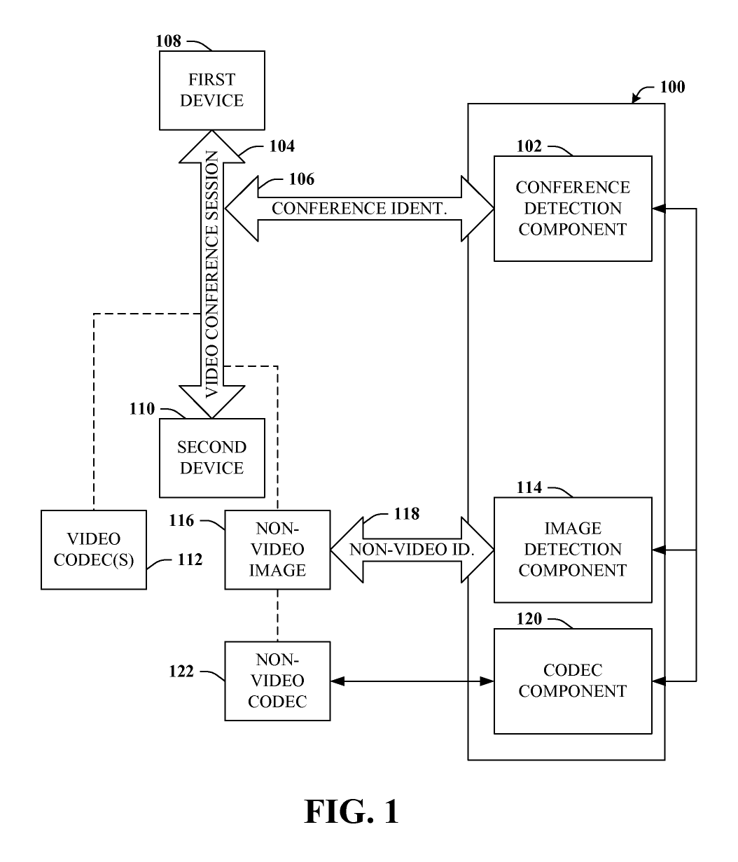

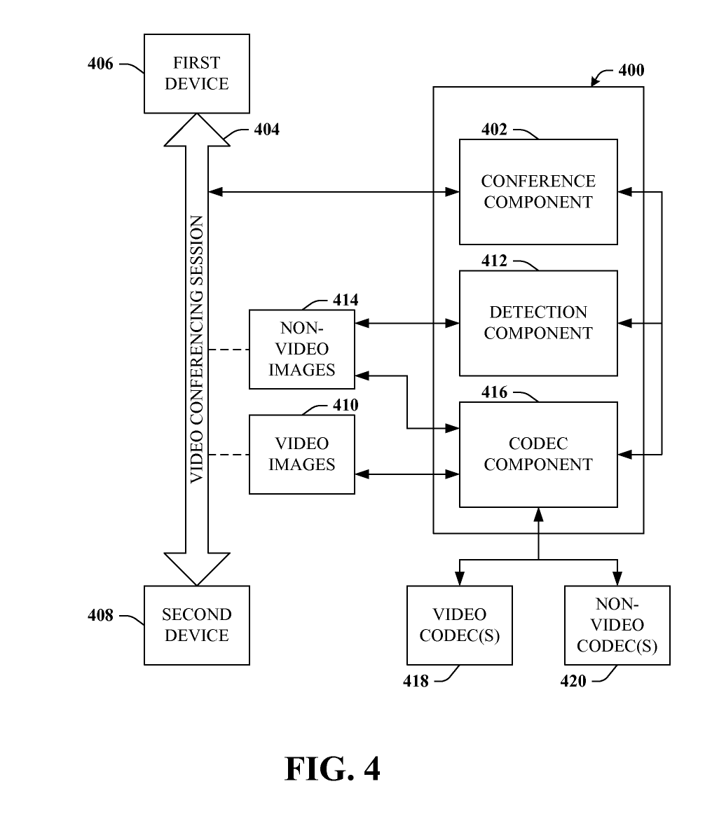

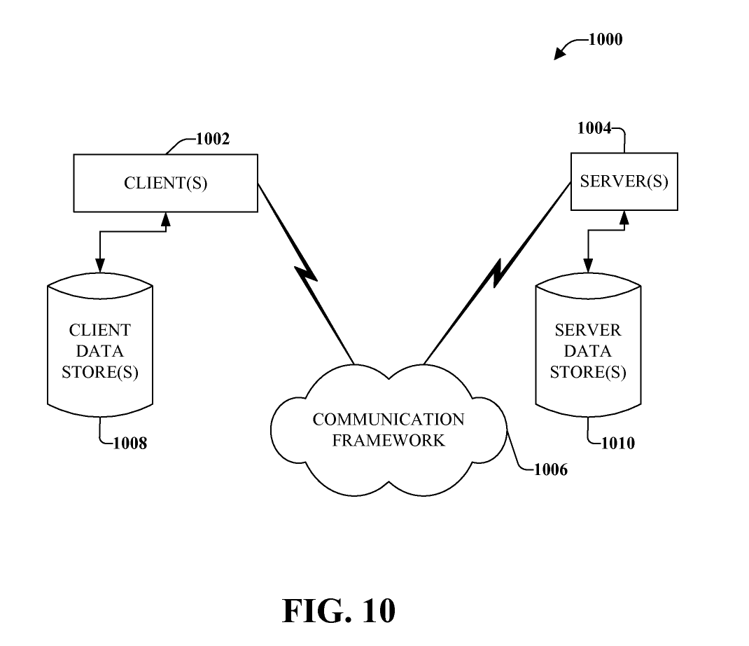

Referring now to FIG. 1, a system 100 is depicted. System 100 can employ a non-video codec to encode/decode a non-video image designated for transfer by way of a video conferencing session. System 100 can include a memory that stores computer executable components and a processor that executes computer executable components stored in the memory, examples of which can be found with reference to FIG. 10. In addition, system 100 can include a conference detection component 102, an image detection component 114, and a codec component 120, any or all of which can interface to a video conferencing application being executed on first device 108 and/or second device 110. In another embodiment further detailed in connection with system 400 of FIG. 4, features disclosed herein can be included in a video conferencing application.

Conference detection component 102 can be configured to identify (e.g., by way of conference identification 106) video conferencing session 104 between first device 108 and second device 110. First device 108 and second device 110 can be substantially any type or types of communication devices such as, for example, personal computers, laptops, smart phones, tablets, gaming consoles, televisions, and so forth. Generally, one or both devices 108, 110 will be executing a video conferencing application (not shown) that employs one or more video codec(s) 112 for encoding video images and transferring those video images by way of video conferencing session 104 in order to facilitate communication between devices 108, 110. Video images that typically include a high degree of motion (e.g., 30 frames per second to approximate real motion), few sharp edges, a rapidly changing picture, and have smooth, natural colors can be efficiently encoded with video codec(s) 112 and shared by way of video conference session 104.

Image detection component 114 can be configured to identify non-video image 116 (e.g., by way of non-video identification 118) in response to non-video image 116 being designated for transfer by way of video conferencing session 104. For example, the non-video image 116 can be a screen capture performed at first device 108 (or second device 110). In contrast to video images commonly exchanged by way of video conference session 104, non-video images 116 typically will be low in motion, have a greater number of sharp edges, will not be expected to change often, and will often include large blocks of a single color. Therefore, encoding non-video image 116 with video codec(s) 112 will likely yield a number of inefficiencies.

For example, the compression/encoding of the non-video image 116 cannot take advantages of compression strategies optimized for still images because video codecs do not expect, e.g., large blocks of a single color. Thus, the non-video image 116 encoded with video codec(s) 112 will require more bandwidth than otherwise might be necessary to transfer by way of video conference session 104. Furthermore, most video compression (e.g., employing video codec(s) 112) is lossy compression. Thus, when decoding at the recipient end, non-video image 116 will be rendered with a loss of detail and quality.

To avoid these inefficiencies as well as to other related ends, codec component 120 can be configured to utilize non-video codec 122 for non-video image 116, wherein non-video codec 122 differs from the one or more video codec(s) 112. For instance, codec component 120 can utilize non-video codec 122 for encoding non-video image 122 prior to transmission by way of video conferencing session 104. Additionally or alternatively, codec component 120 can utilize non-video codec 122 for decoding non-video image 122 after transmission. By utilizing non-video codec 122 rather than video codec(s) 112, which are tailored for video-based compression, non-video image 116 can be rendered at the destination (e.g., device 108 or 110) in higher quality and can often be transmitted more efficiently (e.g., lower bandwidth and/or resource utilization) by way of video conferencing session 104.

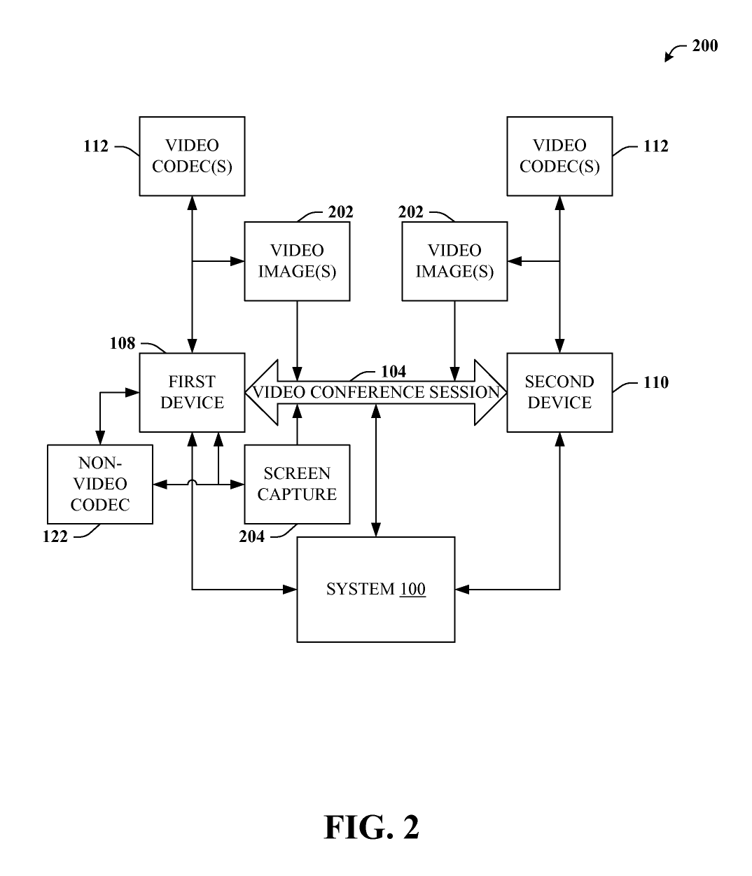

FIG. 2 illustrates one example embodiment in which non-video image 116 is a screen capture performed by first device 108. Turning now to FIG. 2, system 200 is depicted. System 200 can include system 100 (e.g., conference detection component 102, image detection component 114, and codec component 120) or other components detailed herein. The conference detection component 102 can identify video conference session 104 between first device 108 and second device 110. First device 108 utilizes video codec(s) 112 for encoding one or more video image(s) 202 that are communicated to, or to decode video image(s) 202 that are received from, second device 110 by way of video conference session 104. Likewise, second device 110 utilizes video codec(s) 112 for encoding one or more video image(s) 202 that are communicated to, or to decode video image(s) 202 that are received from, first device 108 by way of video conference session 104.

At some point during video conference session 104, first device 108 performs a screen capture 204 and designates screen capture 204for sharing by way of video conference session 104. Image detection component 114 identifies the screen capture 204 (e.g., non-video image 116) designated for sharing by way of video conference session 104. Unlike video image(s) 202, screen capture 204 is not encoded with video codec(s) 112. Instead, codec component 120 utilizes non-video codec 122 to encode screen capture 204, which is then more efficiently transmitted to second device 110 by way of video conference session 104. Second device 110 receives the encoded screen capture 204 provided by first device 108 and codec component 120 utilizes non-video codec 122 to decode the encoded screen capture 204, which is then rendered at second device 110 in higher quality.

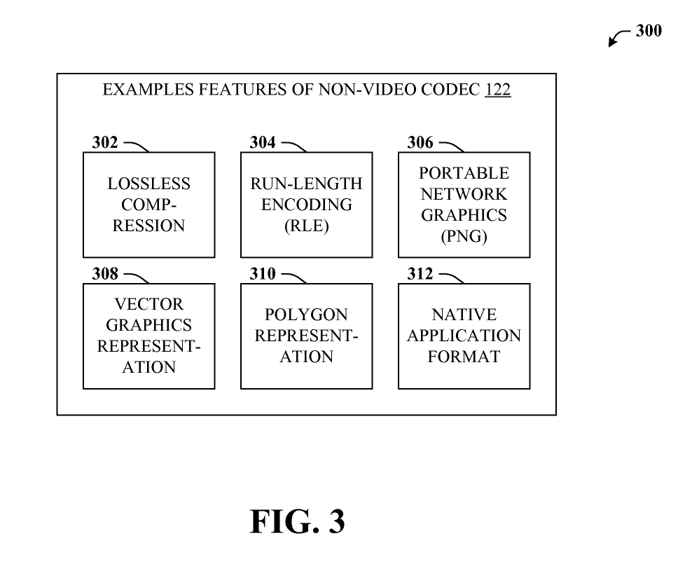

Referring to FIG. 3, illustration 300 is provided. Illustration 300 depicts example features of non-video codec 122 in various embodiments. In one or more embodiments, non-video codec 122 can employ lossless compression 302. In contrast to standard video-based codecs, which are lossy, lossless compression 302 can encode an image and thereafter decode the image without artifacts arising and without the process resulting in a degradation of the quality of the original image.

Two such examples of lossless compression 302 are run-length encoding (RLE) 304 and portable network graphics (PNG) 306. RLE 304 operates to encode data values as the value and a number of consecutive data elements. Thus, images with large blocks of a single color can be efficiently compressed and those original values are maintained for lossless rendering when uncompressed at the destination. PNG 306 utilizes a dynamic Huffman bit reduction encoding strategy that can also identify repeating data elements, and is also effective at compressing images with large blocks of a single color.

Additionally or alternatively, in one or more embodiments, non-video codec 122 can convert non-video image 116 to vector graphics representation 308. Conversion to a vector graphics representation 308 can entail identifying geometrical primitives such as points, lines, curves, shapes, etc. to associated mathematical expressions, which can then be employed to represent images. Vector graphics representation 308 is particularly useful for text-based images and can provide sharp image clarity when rendered at the destination, and can be resized (e.g., zoomed) without any loss of quality.

In other embodiments, non-video codec 122 can convert non-video image 116 to polygon representation 310. For example, non-video codec 122 can identify edges and block colors. These edges and block colors can then be utilized to construct polygon representation 310 that can be useful for charts and graphs as well as for cartoon-style images.

In one or more embodiments, non-video codec 122 can leverage a native application format 312. For example, native application format 312 can be, e.g., a word processor and the non-video codec 122 can identify, e.g., a size of a page, text on a page, font color, font weight and so forth. Such information can be transmitted by way of video conference session 104 and rendered at the destination according to native application format 312.

While still referring to FIG. 3, but turning back to FIG. 1 as well, a common scenario can arise in which one or more of the available non-video codecs 122 will be more efficient than others, generally based upon characteristics of non-video image 116 and possibly based upon characteristics associated with first device 108 and/or second device 110. For example, a screen capture of a word processor text file might be more efficiently shared by leveraging native application format 312, but only if the destination device 108, 110 is equipped with the same or a compatible application. Otherwise, RLE 304, PNG 306 or, particularly in the case where zooming is preferred without a loss of clarity, vector graphics representation 308. In other cases such as where non-video image 116 is a graph, chart, or drawing, polygon representation 310 might be preferred.

In one or more embodiments, codec component 120 and/or image detection component 114 can examine non-video image 116 as well as a configuration or status of first device 108, second device 110 and/or relevant network conditions and intelligently select or infer a particular non-video codec 122 to utilize in connection with non-video image 116.

### Example Embodiment Integrated with a Video Conference Application

With reference now to FIG. 4, system 400 is depicted. System 400 can employ a non-video codec to encode/decode a non-video image designated for transfer by way of a video conferencing session. System 400 can include a memory that stores computer executable components and a processor that executes computer executable components stored in the memory, examples of which can be found with reference to FIG. 10. In addition, system 400 can include a conference component 402, a detection component 412, and a codec component 416, any or all of which can be included in a video conferencing application being executed on first device 406 and/or second device 408.

Conference component 402 can be configured to establish video conference session 404 between first device 406 and second device 408. Once video conference session 404 has been established, first device 406 and second device 408 can communicate by, e.g., exchanging video-based information such as video images 410 captured by an associated camera.

Detection component 412 can be configured to identify one or more non-video images 414 being shared by way of video conference session 404. For example, a given non-video image 414 can be a screen capture performed by either one of first device 406 or second device 408 that is designated for sharing by way of video conference session 404.

Codec component 416 can be configured to utilize one or more video codec(s) 418 to facilitate communication of video images 410 between first device 406 and second device 408. Codec component 416 can also be configured to utilize one or more non-video codec(s) 420 to facilitate communication of the non-video images 414 between first device 406 and second device 408, wherein the non-video codec(s) 420 differ from the video codec(s) 418 utilized in connection with video images 410.

When transmitting non-video images 414 by way of video conference session 404, non-video codec(s) 420 can be utilized to encode the non-video images 414. When receiving encoded non-video images 414, non-video codec(s) 420 can be utilized to decode the encoded non-video images 414. Non-video codec(s) 420 can encode images in a lossless manner and can include one or more of the features detailed in connection with FIG. 3. Furthermore, a determination can be made, possibly based upon an examination of non-video images 414, devices 406, 408, and video conference session 404, as to which particular features of non-video codec(s) 420 are preferred. A selection of a particular non-video codec 420 can then be determined.

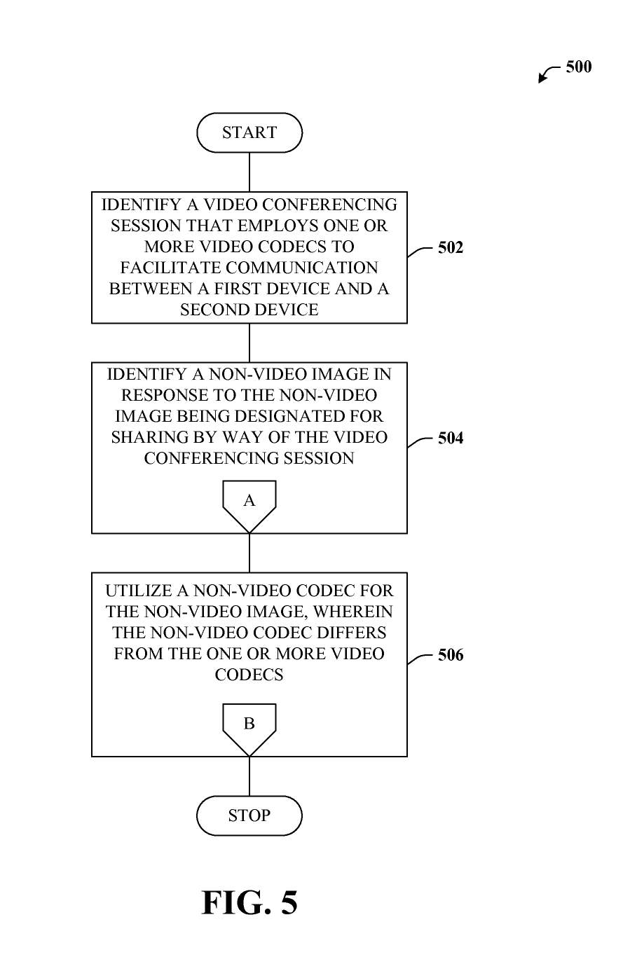

FIGS. 5-8 illustrate various methodologies in accordance with certain embodiments of this disclosure. While, for purposes of simplicity of explanation, the methodologies are shown and described as a series of acts within the context of various flowcharts, it is to be understood and appreciated that embodiments of the disclosure are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers. The term article of manufacture, as used herein, is intended to encompass a computer program accessible from any computer-readable device or storage media.

FIG. 5 illustrates exemplary method 500. Method 500 can employ a non-video codec to encode/decode a non-video image designated for transfer by way of a video conferencing session. For example, at reference numeral 502, a video conferencing session that employs one or more video codecs (e.g., codecs designed to efficiently compress and transfer video images) to facilitate communication between a first device and a second device can be identified (e.g., by a conference detection component).

At reference numeral 504, a non-video image can be identified in response to the non-video image being designated for sharing by way of the video conferencing session. By way of example, the non-video image can be identified by an image detection component.

At reference numeral 506, a non-video codec can be utilized (e.g., by a codec component) for the non-video image. The non-video codec will typically differ from the one or more video codecs utilized to encode video images for the video conferencing session.

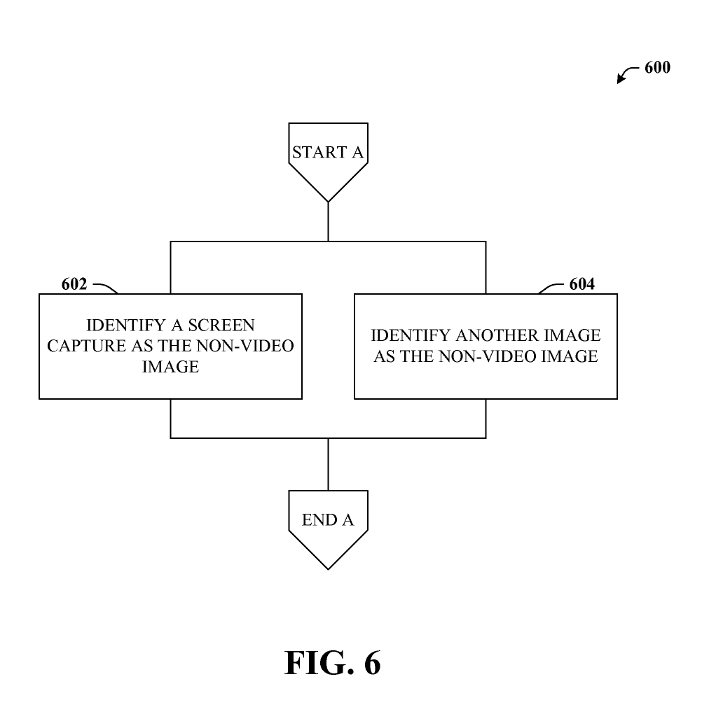

Turning now to FIG. 6, exemplary method 600 is depicted. Method 600 can provide for additional features associated with identifying the non-video image. For example, reference numeral 504 of FIG. 5 can provide for various embodiments associated with identifying the non-video image. Following insert A, reference numeral 602 can be reached. In one or more embodiments, as detailed in connection with reference numeral 602, a screen capture can be identified as the non-video image. For instance, a participant device to the video conferencing session can perform a screen capture and designate that screen capture for sharing by way of the video conference session.

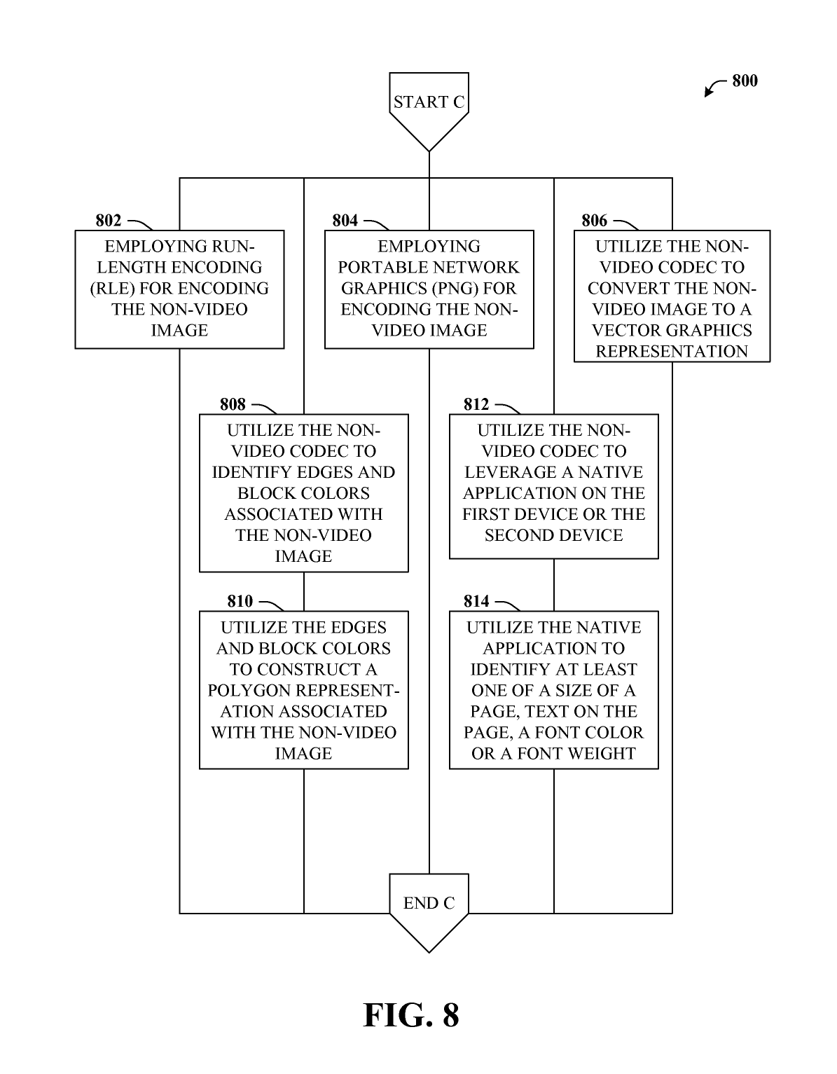

In other embodiments, at reference numeral 604, another image, generally a static image, can be identified as the non-video image. For instance, a data package representative of a screen display at the time of a screen capture can be identified as the non-video image. Various non-limiting examples can be a vector graphics representation, a polygon representation, a native application format, etc., which are further detailed in connection with reference numerals 806-814 of FIG. 8 below.

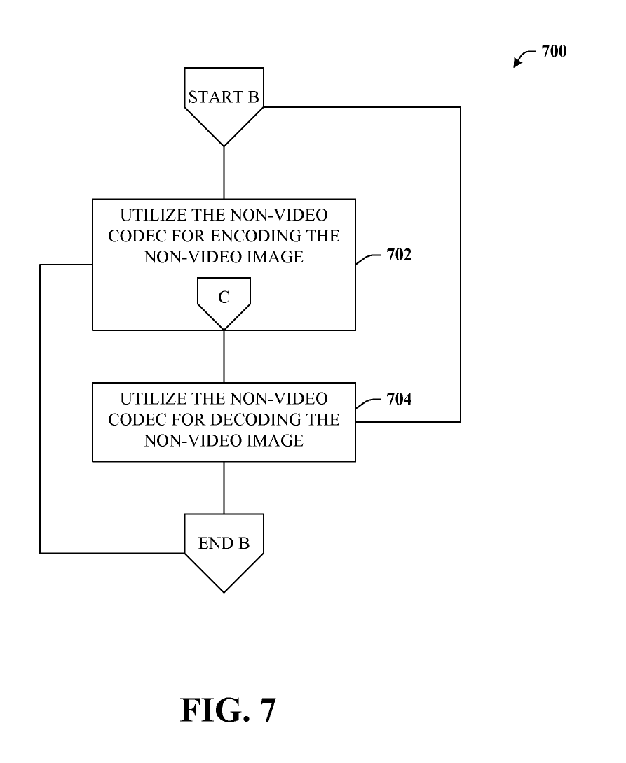

Referring now to FIG. 7, exemplary method 700 can provide for additional features associated with utilizing the non-video codec. For example, reference numeral 506 of FIG. 5 can provide for utilizing the non-video codec in connection with the non-video image. Following insert B, method 700 can start and proceed to either reference numeral 702 or reference numeral 704. In one or more embodiments, at reference numeral 702, the non-video codec can be utilized for encoding the non-video image. For instance, the non-video image can be encoded prior to transmission by way of the video conferencing session.

Thereafter, method 700 can proceed to reference numeral 704 or end. At reference numeral 704, the non-video codec can be utilized for decoding the non-video image. For example, the non-video image will generally be encoded for transmission by way of the video conferencing session, whether such encoding takes place during method 700 or at another time. Upon receipt of this encoded non-video image, the non-video codec can be utilized for decoding.

Turning now to FIG. 8, example method 800 is illustrated. Method 800 can provide for additional features relating to utilizing non-video codec for encoding non-video image as detailed in connection with reference numeral 702 of FIG. 7. Method 800 can begin with the start of insert C. In one or more embodiments, method 800 proceeds to reference numeral 802. At reference numeral 802, run-length encoding (RLE) is employed for encoding the non-video image. RLE can, e.g., efficiently encode images with large blocks of a single color in a lossless manner. Method 800 thereafter ends.

In other embodiments, method 800 proceeds to reference numeral 804. At reference numeral 804, portable network graphics (PNG) is employed for encoding the non-video image. PNG can, e.g., efficiently encode photographic images in a lossless manner. Following execution of reference numeral 804, method 800 ends.

According to other embodiments, method 800 proceeds to reference numeral 806. At reference numeral 806, the non-video codec is utilized to convert the non-video image to a vector graphics representation. Vector graphics representations can, e.g., effectively represent text-based images that can be resized or zoomed without blurring or loss of clarity. After completion of reference numeral 806, method 800 ends.

In one or more embodiments, method 800 initially proceeds to reference numeral 808. At reference numeral 808, the non-video codec is utilized to identify edges and block colors associated with the non-video image. At reference numeral 810, the edges and block colors are utilized to construct a polygon representation of the non-video image. Polygon representations can, e.g., effectively represent graphs, charts, and drawings. Following execution of reference numeral 810, method 800 ends.

In other embodiments, method 800 starts and proceeds to reference numeral 812. At reference numeral 812, the non-video codec is utilized to leverage a native application executing on the first device or the second device. By way of illustration and not limitation, the native application can be a word processor application, a presentation application, a spreadsheet application, and so on. At reference numeral 814, the native application is polled, audited, or otherwise utilized to identify various relevant characteristics of the native application format. For example, the native application can identify at least one of a size of a page, text on the page, a font color, a font weight, and so forth. After reference numeral 814 is executed, method 800 ends.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated herein.

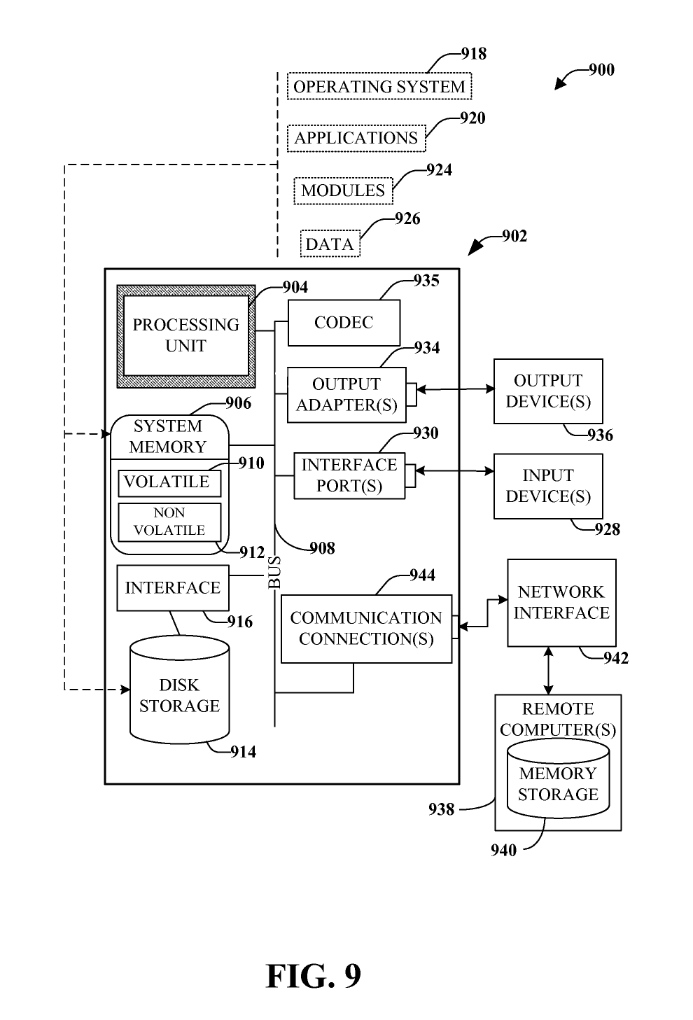

With reference to FIG. 9, a suitable environment 900 for implementing various aspects of the claimed subject matter includes a computer 902. The computer 902 includes a processing unit 904, a system memory 906, a codec 935, and a system bus 908. The system bus 908 couples system components including, but not limited to, the system memory 906 to the processing unit 904. The processing unit 904 can be any of various available processors. Dual microprocessors and other multiprocessor architectures also can be employed as the processing unit 904.

The system bus 908 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 906 includes volatile memory 910 and non-volatile memory 912. The basic input/output system (BIOS), containing the basic routines to transfer information between elements within the computer 902, such as during start-up, is stored in non-volatile memory 912. In addition, according to present innovations, codec 935 may include at least one of an encoder or decoder, wherein the at least one of an encoder or decoder may consist of hardware, software, or a combination of hardware and software. For example, in one or more embodiments, all or portions of codec 935 can be included in codec component 120, 416 and/or non-video codec 122, 420. Although, codec 935 is depicted as a separate component, codec 935 may be contained within non-volatile memory 912. By way of illustration, and not limitation, non-volatile memory 912 can include read only memory (ROM), programmable ROM (PROM), electrically programmable ROM (EPROM), electrically erasable programmable ROM (EEPROM), or flash memory. Volatile memory 910 includes random access memory (RAM), which acts as external cache memory. According to present aspects, the volatile memory may store the write operation retry logic (not shown in FIG. 9) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 902 may also include removable/non-removable, volatile/non-volatile computer storage medium. FIG. 9 illustrates, for example, disk storage 914. Disk storage 914 includes, but is not limited to, devices like a magnetic disk drive, solid state disk (SSD) floppy disk drive, tape drive, Jaz drive, Zip drive, LS-100 drive, flash memory card, or memory stick. In addition, disk storage 914 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 914 to the system bus 908, a removable or non-removable interface is typically used, such as interface 916. It is appreciated that storage devices 914 can store information related to a user. Such information might be stored at or provided to a server or to an application running on a user device. In one embodiment, the user can be notified (e.g., by way of output device(s) 936) of the types of information that are stored to disk storage 914 and/or transmitted to the server or application. The user can be provided the opportunity to opt--in or opt-out of having such information collected and/or shared with the server or application (e.g., by way of input from input device(s) 928).

It is to be appreciated that FIG. 9 describes software that acts as an intermediary between users and the basic computer resources described in the suitable operating environment 900. Such software includes an operating system 918. Operating system 918, which can be stored on disk storage 914, acts to control and allocate resources of the computer system 902. Applications 920 take advantage of the management of resources by operating system 918 through program modules 924, and program data 926, such as the boot/shutdown transaction table and the like, stored either in system memory 906 or on disk storage 914. It is to be appreciated that the claimed subject matter can be implemented with various operating systems or combinations of operating systems.

A user enters commands or information into the computer 902 through input device(s) 928. Input devices 928 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 904 through the system bus 908 via interface port(s) 930. Interface port(s) 930 include, for example, a serial port, a parallel port, a game port, and a universal serial bus (USB). Output device(s) 936 use some of the same type of ports as input device(s) 928. Thus, for example, a USB port may be used to provide input to computer 902 and to output information from computer 902 to an output device 936. Output adapter 934 is provided to illustrate that there are some output devices 936 like monitors, speakers, and printers, among other output devices 936, which require special adapters. The output adapters 934 include, by way of illustration and not limitation, video and sound cards that provide a means of connection between the output device 936 and the system bus 908. It should be noted that other devices and/or systems of devices provide both input and output capabilities such as remote computer(s) 938.

Computer 902 can operate in a networked environment using logical connections to one or more remote computers, such as remote computer(s) 938. The remote computer(s) 938 can be a personal computer, a server, a router, a network PC, a workstation, a microprocessor based appliance, a peer device, a smart phone, a tablet, or other network node, and typically includes many of the elements described relative to computer 902. For purposes of brevity, only a memory storage device 940 is illustrated with remote computer(s) 938. Remote computer(s) 938 is logically connected to computer 902 through a network interface 942 and then connected via communication connection(s) 944. Network interface 942 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 944 refers to the hardware/software employed to connect the network interface 942 to the bus 908. While communication connection 944 is shown for illustrative clarity inside computer 902, it can also be external to computer 902. The hardware/software necessary for connection to the network interface 942 includes, for exemplary purposes only, internal and external technologies such as, modems including regular telephone grade modems, cable modems and DSL modems, ISDN adapters, and wired and wireless Ethernet cards, hubs, and routers.

Referring now to FIG. 10, there is illustrated a schematic block diagram of a computing environment 1000 in accordance with this specification. The system 1000 includes one or more client(s) 1002 (e.g., laptops, smart phones, PDAs, media players, computers, portable electronic devices, tablets, and the like). The client(s) 1002 can be hardware and/or software (e.g., threads, processes, computing devices). The system 1000 also includes one or more server(s) 1004. The server(s) 1004 can also be hardware or hardware in combination with software (e.g., threads, processes, computing devices). The servers 1004 can house threads to perform transformations by employing aspects of this disclosure, for example. One possible communication between a client 1002 and a server 1004 can be in the form of a data packet transmitted between two or more computer processes wherein the data packet may include video data. The data packet can include a cookie and/or associated contextual information, for example. The system 1000 includes a communication framework 1006 (e.g., a global communication network such as the Internet, or mobile network(s)) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

In one embodiment, a client 1002 can transfer an encoded file, in accordance with the disclosed subject matter, to server 1004. Server 1004 can store the file, decode the file, or transmit the file to another client 1002. It is to be appreciated, that a client 1002 can also transfer uncompressed file to a server 1004 and server 1004 can compress the file in accordance with the disclosed subject matter. Likewise, server 1004 can encode video information and transmit the information via communication framework 1006 to one or more clients 1002.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

What is claimed is:

1. A system, comprising:
a memory that stores computer executable components; and
a microprocessor that executes the following computer executable components stored in the memory:
a conference detection component that identifies a video conference session between a first device and a second device, the video conference session employs one or more video codecs to facilitate communication between the first device and the second device;
an image detection component that identifies a non-video image in response to the non-video image being designated for transfer by way of the video conference session; and
a codec component that utilizes a non-video codec for the non-video image, wherein the non-video codec differs from the one or more video codecs.

2. The system of claim 1, wherein the non-video image is a computer screen capture.

3. The system of claim 1, wherein the codec component utilizes the non-video codec to encode the non-video image.

4. The system of claim 1, wherein the codec component utilizes the non-video codec to decode the non-video image.

5. The system of claim 1, wherein the non-video codec employs lossless compression for encoding the non-video image.

6. The system of claim 1, wherein the non-video codec employs run-length encoding (RLE) for encoding a bitmap of the non-video image.

7. The system of claim 1, wherein the non-video codec employs portable network graphics (PNG) for encoding a bitmap the non-video image.

8. The system of claim 1, wherein the non-video codec converts the non-video image to a vector graphics representation.

9. The system of claim 1, wherein the non-video codec identifies edges and block colors and converts the non-video image to a polygon representation.

10. The system of claim 1, wherein the non-video codec leverages a native application format extant on the first device or the second device.

11. The system of claim 10, wherein the native application is a word processor and the non-video codec identifies at least one of: size of a page, text on the page, font color, or font weight.

12. A system, comprising:
a memory that stores computer executable components; and
a microprocessor that executes the following computer executable components stored in the memory:
a conference component that establishes a video conferencing session between a first device and a second device;
a detection component that identifies a non-video image being shared by way of the video conferencing session; and
a codec component that utilizes one or more video codecs to facilitate communication of video images between the first device and the second device and utilizes a non-video codec to facilitate communication of the non-video image between the first device and the second device, wherein the non-video codec differs from the one or more video codecs.

13. The system of claim 12, wherein the non-video image is a screen capture.

14. The system of claim 12, wherein the codec component utilizes the non-video codec to encode the non-video image or to decode the non-video image.

15. The system of claim 12, wherein the codec component employs lossless compression for encoding the non-video image.

16. A method, comprising:
employing a microprocessor to execute computer executable components stored within a memory to perform the following:
identifying a video conferencing session between a first device and a second device, the video conferencing session employs one or more video codecs to facilitate communication between the first device and the second device;
identifying a non-video image in response to the non-video image being designated for sharing by way of a video conferencing session; and
utilizing a non-video codec for the non-video image, wherein the non-video codec differs from the one or more video codecs.

17. The method of claim 16, wherein the non-video image is a screen capture.

18. The method of claim 16, wherein the non-video codec employs lossless compression for encoding the non-video image.

19. The method of claim 16, wherein the non-video codec converts the non-video image to a vector graphics representation or to a polygon representation.

20. The method of claim 16, wherein the non-video codec leverages a word processor application extant on the first device or the second device.
